(19) United States
(12) Patent Application Publication
(10) Pub. No.: US 2015/0190941 A1
(43) Pub. Date: Jul. 9, 2015

(54) DIE SURFACE AND LUBRICATION FOR CUTTING LITHIUM METAL

(71) Applicant: Medtronic, Inc., Minneapolis, MN (US)

(72) Inventor: Joseph J. Viavattine, Vadnais Heights, MN (US)

(21) Appl. No.: 14/151,230

(22) Filed: Jan. 9, 2014

(51) Int. Cl. B26D 7/08

(52) U.S. Cl. CPC B26D 7/088

(57) ABSTRACT

Propylene carbonate is used as a lubricant for cutting lithium metal with a die having a metal cutting surface.

### FIELD

The disclosure relates to dies and methods for cutting lithium metal.

### BACKGROUND

Cutting lithium metal can be challenging because it tends to stick to the die cutting surfaces and quickly builds up over time. This can make releasing the cut part near impossible without distorting it. Non-stick surfaces and lubricants are known. Such nonstick surfaces include polymer parting sheets, talc, and oxide coatings. A well-known lubricant used for cutting lithium metal is heptane. Plastic sheets or films work well for cutting thin sheets lithium parts but shred and distort thicker lithium metal parts. Heptane requires special handling, talc introduces foreign material into finished products such as batteries, and oxide coatings appear to be more suitable for rolling applications than for cutting applications.

### SUMMARY

In one embodiment, the disclosure provides a cutting die useful for cutting lithium metal. The cutting die comprises a metal cutting surface having propylene carbonate on the cutting surface. The propylene carbonate may be applied directly or as a component in a composition.

In another embodiment, the disclosure provides a method of cutting lithium metal. The method comprises providing a cutting die having a metal cutting surface which has propylene carbonate on the cutting surface and cutting the lithium metal with the propylene carbonate-treated cutting surface.

### DETAILED DESCRIPTION

This disclosure describes cutting dies and methods for cutting lithium metal. Lithium metal is typically used as anode material in electrochemical cells, for example batteries. Lithium anodes (negative electrodes) for batteries are typically made from precisely cut sheets of lithium metal. The lithium metal sheets may have a thickness that ranges from 0.1 min to 5 mm. In other embodiments, the lithium metal sheets may have a thickness at least 0.1 mm and not more than 5 mm, and may have a thickness of any range or value in between 0.1 mm and 5 mm. The anodes may be made from a single layer or multiple layers that are stacked.

Applicants have found that the use of propylene carbonate as a lubricant on the cutting surface of cutting dies provides improved release of the cut lithium metal part from the die. Examples or improved release include the lack of or minimal sticking of the lithium metal to the die and no unacceptable deformation of the die cut lithium metal part. “Unacceptable deformation” means deformation that is not acceptable for the intended use of the die cut lithium metal part.

In one embodiment, the cutting surface of the cutting die comprises titanium metal that has been treated with nitrogen or has been “nitrogenized” and has been exposed to, treated with, coated with, or dipped into propylene carbonate. Applicants have found that nitrogen-treated titanium cutting surfaces further treated with propylene carbonate are useful for cutting lithium metal sheets having a thickness of from 0.1 mm and 5 mm, as described above.

In other embodiments, the lithium metal to be die cut has a thickness of from 0.1 mm to 5 mm and the cutting surface of the cutting die comprises bare steel exposed to, treated with, coated with, or dipped into propylene carbonate.

Applicants have found that the use of propylene carbonate on cutting die surfaces prevents the amount of lithium metal that sticks to the cutting surface and also increases the release of the cut lithium metal part from the die. The use or propylene carbonate also increases the number of cycles or parts that can be cut with the cutting surface before propylene carbonate needs to be re-applied as compared to other release agents.

In another embodiment, propylene carbonate is added to a sponge such that the sponge is saturated with propylene carbonate. Cutting surfaces of dies can be periodically dipped into the propylene carbon saturated sponge for the lubricating treatment.

In another embodiment, compositions containing propylene carbonate, are used as a lubricant for die cutting lithium metal. For example, an electrolyte containing propylene carbonate at a level of at least 5% by weight can be used as a die lubricant or release agent. In other embodiments, the composition can contain, comprise, consist essentially of or consist of at least 10%, 20%, 30%, 40%, 50%, 60% or at least 70% by weight propylene carbonate. In other embodiments, the composition can contain, comprise, consist essentially of or consist of from 5% to 100% by weight propylene carbonate and may contain any amount or range between 5% and 100%.

The methods and die assemblies disclosed in this application do not include the use of parting sheets, polymer sheets, paper sheets, talc, oxide coatings on the cutting die or heptane on the cutting die for cutting lithium metal.

### EXAMPLES

### Comparative Examples 1 and 2

Steel and titanium cutting dies having been nitrogenized (in the case of the steel) and a titanium nitride coating were used to cut lithium metal sheets having a thickness of 0.1 mm. Both the treated steel and the titanium nitride cutting surfaces provide one cut or cycle before the lithium metal started to stick to the cutting surfaces.

### Comparative Examples 3 and 4

Cutting surfaces of bare steel and bare titanium cutting dies were exposed to propylene carbonate. It was observed that the propylene carbonate formed “beads” of liquid on both surfaces.

### Example 1

The cutting surface of a titanium nitride coated titanium cutting die was dipped into and exposed to propylene carbonate. It was observed that the propylene carbonate “wetted out” on the surface. The titanium nitride coated titanium cutting dies was used to cut greater than 20 lithium metal parts from lithium metal sheets having a thickness of 0.25 mm without unacceptable deformation or sticking with a single application of propylene carbonate.

### Example 2

The cutting surface of a bare steel cutting die was dipped into and exposed to propylene carbonate. Lithium metal having a thickness of 1.2 mm was die cut without any unacceptable distortion or release problems.

1. A cutting die comprising:
a cutting die having a metal cutting surface; and
propylene carbonate on the metal cutting surface.

2. The cutting die of claim 1 wherein the cutting surface thermally treated with nitrogen.

3. The cutting die of claim 2 wherein the cutting surface treated with nitrogen includes a nitride on the cutting surface.

4. The cutting die of claim 3 wherein the nitride is titanium nitride, titanium aluminum nitride, aluminum titanium nitride, or boron nitride.

5. The cutting die of claim 1 wherein the metal cutting surface comprises bare steel.

6. The cutting die of claim 1 wherein the propylene carbonate is present in a composition.

7. The cutting die of claim 6 wherein the composition is an electrolyte.

8. The cutting die of claim 6 wherein the propylene carbonate is present in the composition in an amount of at least 5% by weight.

9. A method of cutting lithium metal comprising:
providing a cutting die having a metal cutting surface;
applying propylene carbonate to the treated cutting surface; and
cutting lithium metal by contacting the treated cutting surface of the die with the lithium metal using sufficient force.

10. The method of claim 9 wherein the propylene carbonate is applied to the metal cutting surface through contact with a sponge saturated with a composition comprising propylene carbonate.
